(19) United States
(12) Patent Application Publication
(10) Pub. No.: US 2019/0026288 A1
(43) Pub. Date: Jan. 24, 2019

(54) ELECTRONIC SYSTEM FOR MANAGING DIGITAL MULTIMEDIA CONTENTS

(71) Applicant: Your Voice USA Corp., New York, NY (US)

(72) Inventors: Roberto Piroddi, Milan (IT); Bret Schlussman, New York, NY (US); Paolo Siligoni, Milan (IT); Luca Agostini, Milan (IT); Andrea Stroppa, Milan (IT)

(21) Appl. No.: 16/041,377

(22) Filed: Jul. 20, 2018

Related U.S. Application Data
(60) Provisional application No. 62/535,582, filed on Jul. 21, 2017.

(51) Int. Cl. G06F 17/30

(52) U.S. Cl. CPC G06F 17/30058; G06F 17/30867; G06F 17/30887

(57) ABSTRACT

An electronic system for managing digital multimedia contents includes: a processor; a memory coupled to said processor; an internet communication interface coupled to the processor and providing internet connectivity to the processor. The processor is configured to communicate with at least one remote apparatus through said internet communication interface. The processor is configured to: provide the remote apparatus with a graphical user interface; receive from the remote device one or more indications to arrange according to a determined arrangement one or more items. The items arranged according to the determined arrangement define an overall digital multimedia content. The processor is configured to: store in the memory said overall digital multimedia content; generate a main link to retrieve in the memory said overall digital multimedia content; provide the main link to said remote apparatus through the internet communication interface.

### CROSS-REFERENCE TO RELATED APPLICATIONS

This application claims the benefit of U.S. Provisional Application No. 62/535,582, filed Jul. 21, 2017, which is incorporated herein by specific reference.

### BACKGROUND OF THE INVENTION

As known, management and distribution of digital multimedia contents is one of the most important aspects concerning the use of electronic devices (especially mobile devices) and internet connectivity.

People wish to share any kind of digital contents. Companies make accurate use of new technologies in order to set up and distribute advertisement material, always attempting to reach suitable targets as precisely as possible.

The applicant has noticed that the state of the art does not make available tools which are sufficiently user-friendly, simple and, at the same time, effective and which allow the management and distribution of multimedia digital contents, such as for example advertisement campaigns.

### SUMMARY OF THE INVENTION

It is an object of the present invention to provide an electronic system which allows, in a simple and intuitive way, the management and distribution of digital multimedia contents.

This and other objects are achieved by the electronic system according to the appended claims.

The electronic system for managing digital multimedia contents comprises a processor, a memory coupled to said processor and an internet communication interface coupled to said processor and providing internet connectivity to said processor.

Preferably, said processor being configured to communicate with at least one remote apparatus through said internet communication interface.

Preferably, said processor is configured to provide said remote apparatus with a graphical user interface.

Preferably, said processor is configured to receive through said graphical user interface, from said remote apparatus, indications to arrange, according to a determined arrangement, one or more items.

Preferably, said one or more items include one or more of the following:
one or more images;
one or more videos;
one or more audio files;
one or more text portions.

Preferably, said one or more items arranged according to said determined arrangement define an overall digital multimedia content.

Preferably, said processor is configured to store in said memory said overall digital multimedia content.

Preferably, said processor is configured to generate a main link to retrieve in said memory said overall digital multimedia content.

Preferably, said processor is configured to provide said main link to said remote apparatus through said internet communication interface.

Preferably, said processor is configured to display through said graphical user interface a plurality of templates.

Preferably, said processor is configured to prompt a user of said remote apparatus to select one of said templates.

Preferably, said processor is configured to receive from said remote apparatus a first selection signal, representative of a selected template among said templates.

Preferably, said determined arrangement is defined by said selected template.

Preferably, said processor is configured to prompt the user of said remote apparatus to generate a second selection signal to select among the following types of digital multimedia contents:
Images;
Videos;
Event;
Location.

Preferably, the first selection signal is received before the second selection signal.

Preferably, the second selection signal is received before the first selection signal.

Preferably, the first and second selection signal are the same signal, said same signal being indicative of the selected type of digital multimedia content and of the arrangement of the items included in said digital multimedia content.

Preferably, the second selection signal is representative of the selection of the Event type, said processor being configured to:
prompt the user of the remote apparatus to input time reference data associated with the event;
store the time reference data in said memory, in association with the items inserted in said selected template.

Preferably, the second selection signal is representative of the selection of the Event type, said processor being configured to:
prompt the user of the remote apparatus to input geographical reference data associated with the event;
store the geographical reference data in said memory, in association with the items inserted in said selected template.

Preferably, the selection signal is representative of the selection of the Location type, said processor being configured to:
prompt the user of the remote apparatus to input geographical reference data associated with the location;
store the geographical reference data in said memory, in association with the items inserted in said selected template.

Preferably, the selection signal is representative of the selection of the Location type, said processor being configured to store in said memory, instructions/data associated to said geographical reference data which, when provided to an electronic device, display an indication item on a map displayed on a screen of said electronic device, said indication item being representative of said geographical reference data in said map.

Preferably, said processor is configured to:
receive from said remote apparatus a list of contacts;
send said main link to the contacts of said list of contacts.

Preferably, said processor is configured to:
prompt the user of said remote apparatus to create a response form;
receive instruction for creation of said response form;
store the response form in said memory, in association with said overall digital multimedia content.

According to a further aspect, the invention is directed to a method for managing digital multimedia contents, comprising:
establishing an internet connection between a processor and a remote apparatus;
activating the processor to provide the remote apparatus with a graphical user interface;
activating said processor to display through said graphical user interface a plurality of templates;
activating said processor to prompt a user of said remote apparatus to select one of said templates;
receiving at said processor, through said graphical user interface, from said remote apparatus, indications to arrange, according to a determined arrangement, one or more items including one or more of the following:
one or more images;
one or more videos;
one or more audio files;
one or more text portions;

wherein said one or more items arranged according to said determined arrangement define an overall digital multimedia content, the method further comprising:
storing in said memory said overall multimedia digital content;
generating a main link to retrieve in said memory said overall multimedia digital content;
providing said main link to said remote apparatus through said internet communication interface.

According to a further aspect, the invention is directed to a non-transitory computer readable storage medium storing one or more programs comprising instructions, which when executed by an electronic system cause the electronic system to:
establish an internet connection between a processor of said electronic system and a remote apparatus;
activate the processor to provide the remote apparatus with a graphical user interface;
receive at said processor, through said graphical user interface, from said remote apparatus, indications to arrange, according to a determined arrangement, one or more items including one or more of the following:
one or more images;
one or more videos;
one or more audio files;
one or more text portions;

wherein said one or more items arranged according to said determined arrangement define an overall digital multimedia content;
store in said memory said overall multimedia digital content;
generate a main link to retrieve in said memory said overall multimedia digital content;
provide said main link to said remote apparatus through said internet communication interface.

### BRIEF DESCRIPTION OF THE DRAWINGS

Further features and advantages will become more apparent from the following description, which discloses preferred embodiments of the invention. Such description is provided with reference to the attached non-limiting drawings, wherein:

FIG. 1 is a block diagram of the electronic system according to the invention;

FIG. 2 is a schematic representation of a graphical user interface used in the system of FIG. 1, in a first operative condition;

FIG. 3 is schematic representation of the graphical user interface of FIG. 2, in a second operative condition.

### DETAILED DESCRIPTION OF PREFERRED EMBODIMENTS OF THE INVENTION

With reference to the attached drawings, an electronic system according to the present invention is denoted at 1.

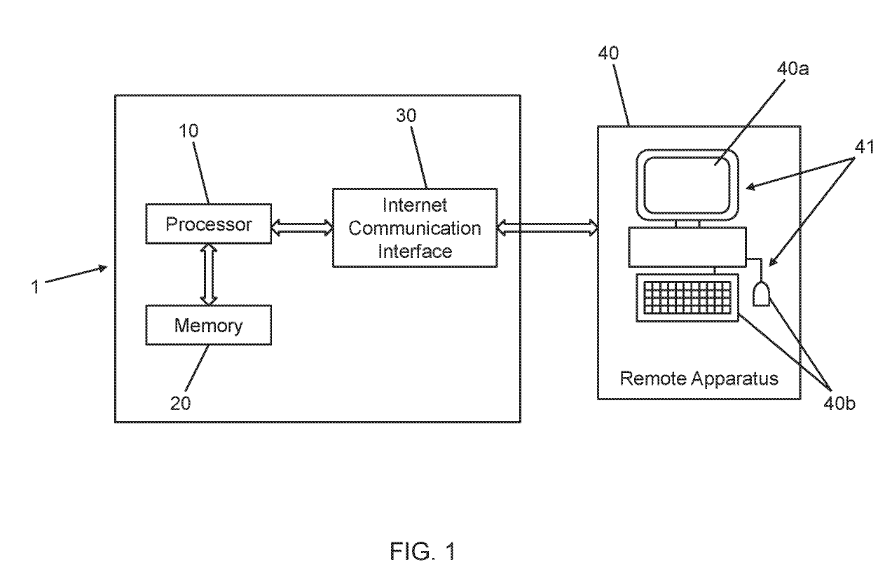

The system 1 (FIG. 1) comprises a processor or CPU 10.

The processor 10 is in electrical communication with a read only memory and/or a random access memory, which form a memory system coupled to the processor 10. Such memory system will be designated in the following as memory 20. In one embodiment, the processor 10 can include or be connected to a cache of high-speed memory, in which the processor 10 can copy data from memory 20 in order to quickly access the same.

The processor 10 can comprise a general purpose processor and any other hardware/software modules configured and/or programmed in order to carry out the operations disclosed and claimed herebelow.

As said, the system 1 further comprises a memory 20, coupled to the processor 10.

The memory 20 is a non-volatile memory in which data necessary for carrying out the invention is stored.

The system 1 further comprises an internet communication interface 30 coupled to the processor 10.

The internet communication interface 30 provides internet connectivity to the processor 10. Such connectivity can be both of the cabled or wireless type.

The electronic system 1 can be realized as a conventional server computer, which is specifically configured and programmed to access the internet and carry out the operations described in the following.

The internet communication interface 30 allows processor 10 to connect, thorough the internet, with at least one remote apparatus 40.

It is to be noted that, preferably, processor 10 connects with a plurality of remote devices.

From a practical/business point of view, the remote apparatus is a computer through which an individual or a company wishes to manage and distribute digital multimedia contents. The electronic system 1 provides support for such activity.

In other terms, the remote apparatus 40 can be realized as a conventional computer system (server computer, personal computer, laptop, mobile device as a smartphone, a tablet, etc.) provided with internet connectivity in order to receive support from the electronic system 1.

The remote apparatus 40 is provided with a user interface 41, comprising at least a screen or display 40a and a data input device 40b. In one embodiment, the data input device 40b can include a keyboard and a mouse. In one embodiment, the data input device 40b can be implemented through a touch-screen capability of the display 40a; in other terms, the user of the remote apparatus 40 can input data in the same remote apparatus 40 by gestures (e.g., tap, drag, swipe, etc.) applied to the touch-screen display 40a. When text portions have to be input, a virtual keyboard is displayed on the touch-screen display 40a and the user can tap on the letters shown in such virtual keyboard.

The data input device 40b allows the user of the remote apparatus 40 to interact with the same remote apparatus 40 through the graphical user interface 100 that will be disclosed in the following.

The remote apparatus 40 is provided with a web-browser and suitable connection device(s) in order to connect to the electronic system 1.

For each of the operations disclosed in the following, the processor 10 and the remote apparatus 40 exchange electrical signals through the internet, in order to provide the other party (processor 10 in case of the apparatus 40, apparatus 40 in case of the processor 10) with the necessary commands/data/information.

Preferably, processor 10 provides support to a number of remote devices, each of which is used to manage and distribute digital multimedia contents.

Initially, the remote apparatus 40 accesses the electronic system 1 through the internet, according to technologies which are per se known.

The processor 10 then provides the remote apparatus 40 with a graphical user interface 100.

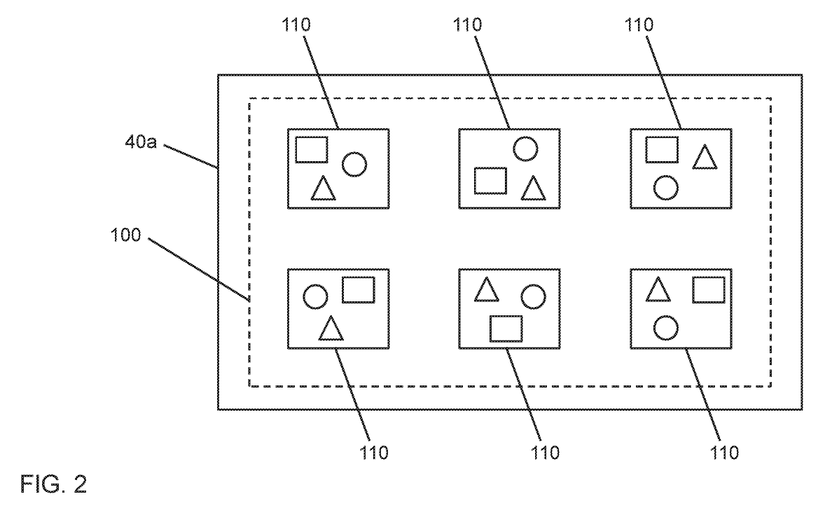

Such graphical user interface 100 is displayed the display 40a of the remote apparatus 40 (FIG. 2).

In other terms, in response to an access request from the remote apparatus 40, the processor 10 sends a first electrical signal to the same remote apparatus 40 including commands/data so that the web-browser running on the remote apparatus 40 displays, on the display 40a, the graphical user interface 100.

The graphical user interface 100 helps the user of the remote apparatus 40 to manage the desired contents.

In more detail, the processor 10 displays, through the graphical user interface 100, a plurality of templates 110.

Each template 110 provides a different arrangement for contents/items, which the user of the remote apparatus 40 wishes to arrange and distribute.

Then the processor 10, through the graphical user interface 100, prompts the user to select one of the templates 110.

Once the selection is made (e.g., the user clicks or taps on the chosen template), a selection signal is sent from the remote apparatus 40 to the processor 10, such selection signal being indicative of the selected template.

After receiving the selection signal, the processor 10 makes the templates other than the selected template disappear from the graphical user interface 100.

The user of the remote apparatus 40 has thus the possibility to fill in the selected template.

After the selection of the desired template, the processor 10 preferably arranges the graphical user interface 100 so as to let the user of the remote apparatus 40 prepare the multimedia contents to be managed.

In particular, the processor 10 sends a second electrical signal to the remote apparatus 40 so that the web browser running thereon displays, on the display 40a, the graphical user interface 100 according to the arrangement disclosed herebelow.

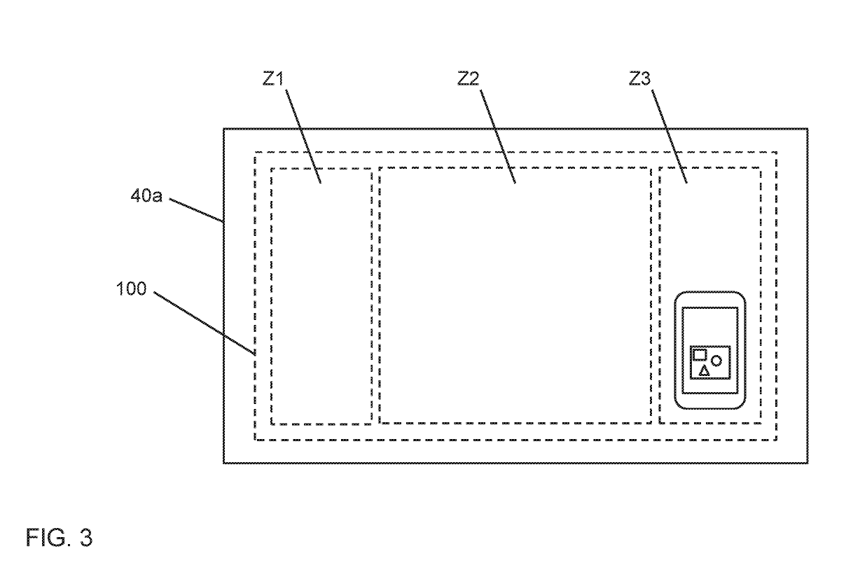

Preferably, the graphical user interface 100, at this stage, includes a first zone Z1 (FIG. 3) wherein the user of the remote apparatus 40 can insert one or more of the following:
text description of the multimedia contents;
a representative image associated with the multimedia contents, which will be coupled to the main link that will be described below;
a link to tracking tools, such as for example Google® Analytics, Facebook® Pixel ID, etc.;
a link to a download area (Apple® Store, Google® Play, etc.) wherein an app, such as for example a mobile app, associated with the multimedia contents can be downloaded;
ax expiration date and, possibly, an expiration time, after which the multimedia contents will not be available anymore.

Preferably, the graphical user interface 100, at this stage, includes a second zone Z2, through which the multimedia contents can be added/inserted, as disclosed in the following. In the second zone Z2 tools such as buttons, menus, etc., are made available to the user of the remote apparatus 40 in order to let him/her insert the multimedia contents to be managed/distributed.

Preferably, the graphical user interface 100, at this stage, includes a third zone Z3, wherein a preview of the inserted/added multimedia contents is displayed. In practical terms, in the third zone Z3 a mobile device (e.g., a smartphone) is pictorially represented and, as the contents are inserted by the user of the remote apparatus 40 through the second zone Z2, the third zone Z3 provides a real-time updated preview of what will be displayed on a final user's device.

Preferably, as schematically shown in FIG. 3, the first, second and third zone Z1, Z2 and Z3 are displayed substantially simultaneously, the first zone Z1 being defined in the leftmost part of the display 40a, the second zone Z2 being defined in the central part of the display 40a, and the third zone Z3 being defined in the rightmost part of the display 40a.

It has to be noticed that the first, second and third zone Z1, Z2 and Z3 can be displayed according to a different arrangement without departing from the scope of the present invention.

In particular, the selected template has a plurality of defined areas/spots. In each of such areas/spots, a respective content item can be inserted.

Items that can be inserted in the template include:

one or more images;

one or more videos;

one or more audio files;

one or more text portions;

one or more dates or ranges of dates;

one or more geographical indications.

Each item can be manually created and added by the user (e.g., text portions).

Each item can be retrieved by the remote apparatus 40 (e.g., on the internet, in a memory of the same remote apparatus 40) and added into the selected template by the remote apparatus 40 upon suitable command by the user.

The insertion of an item in the template can be obtained, for example, by a drag operation, through which the item (e.g., represented by an icon on the display of the remote apparatus 40) is dragged into the template, in the desired spot/area.

The drag operation can be performed either by means of a mouse, in case a traditional computer is used, or by means of a drag gesture in case the display 40a is provided with a touch-screen capability.

Advantageously, the graphic user interface 100 provides for a rescaling feature, in particular for text/images, which can be either automatic or manually operated, in order to adjust the dimensions of the item with respect to those of the respective spot/area.

Preferably, for each operation that is performed through the remote apparatus 40 by means of the graphical user interface 100, a corresponding command (embedded in a respective electrical signal, transmitted through the internet) is sent to the processor 10, representing the operation that has been performed. The content of such command is stored in memory 20.

Accordingly, processor 10 can store in memory 20 the most updated version of the job made through the remote apparatus 40.

Preferably, the processor 10 is configured to process (e.g., reduce dimensions, arrange in different format, etc.) the contents uploaded by the user of the remote apparatus 40, so as to render such contents accessible/usable by final users (which will be disclosed in the following) by means of respective mobile devices, through internet connection.

All the contents and related information uploaded by the user of the remote apparatus 40 through the graphical user interface 100 form an overall multimedia content.

In one embodiment, the overall multimedia content forms or is part of an advertisement campaign. Thus the items uploaded by the user of the remote apparatus 40 can promote, for example, products, services, events, locations, companies, etc. It is however envisaged that the overall multimedia content may also have a different purpose, such as for example simply sharing contents among users of digital devices.

In a preferred embodiment, the overall multimedia content designed through the graphical user interface 100 can be of one of the following types:
Images;
Videos;
Event;
Location.

Preferably, the processor 10, through the graphical user interface 100, prompts the user of the remote apparatus 40 to select one among these four types.

In case “Images” is selected, the processor 10 prompts the user to load one or more images into the selected template. It is envisaged that images can be inserted in the template, and/or links pointing to images.

In case “Videos” is selected, the processor 10 prompts the user to load one or more video files into the selected template. It is envisaged that videos can be inserted in the template, and/or links pointing to videos.

In case “Event” is selected, the processor 10 prompts the user to define a date or a range of dates, plus possibly a time or a time interval. Multimedia contents describing the event (images, videos, text portions, etc.) can be added in the selected template. The processor 10 can also prompt the user of the remote apparatus 40 to input a geographical position, representative of the place/location wherein the event is to take place.

In one embodiment, the user of the remote apparatus 40, through the graphical user interface 100, is given the opportunity to add, to the multimedia contents, an event link that for example points to the official website of the event or other websites associated with the event.

In case “Location” is selected, the processor 10 prompts the user of the remote apparatus 40 to indicate a geographical position (preferably with the aid of a graphical map). Multimedia contents describing the place/location (images, videos, text portions, etc.) can be added in the selected template.

In one embodiment, the user of the remote apparatus 40, through the graphical user interface 100, is given the opportunity to add, to the multimedia contents, a location link that for example points to the official website of the location or other websites associated with the location.

Preferably, the user of the remote apparatus 40 is given the opportunity to add, through the graphical user interface 100, contact information associated with the location. Such contact information will be displayed by the final users, along with the multimedia contents, so that the final users will be able to contact personnel connected with the location.

In case a geographical position is input by the user of the remote apparatus 40, the processor 10 can further prompt the user of the remote apparatus 40 to specify whether the geographical position has to be highlighted on maps.

Once all the items have been inserted and are arranged according to the selected template, the overall multimedia content is defined.

The overall multimedia content, be it of the images, videos, event or location type, is stored in the memory 20 by processor 10. The overall multimedia content include data/information, preferably generated by the processor 10 and stored in memory 20, indicative of the arrangement of the various items according to the selected template.

In one embodiment, in case one or more items have been added as links, the processor 10 is configured to retrieve the respective item and store it in the memory 20.

In one embodiment, in case one or more items have been added as links, the processor 10 in configured to store in the memory 20 such links.

In case the user of the remote apparatus 40 has specified that a geographical position has to be highlighted on maps, the processor 10 inserts in the overall multimedia content a map, wherein the geographical position is highlighted, for example by means of an indicator (so-called “pin”), possibly coupled with a text/graphical description of the location/event associated with such position.

In addition to the above, the processor 10 can be configured to prompt the user of the remote apparatus 40 to create/define a response form. The user of the remote apparatus 40 can be prompted, in particular, to define the field(s) that the response form has to include, the shape/size of the response form, how the fields are arranged relative to each other, etc.

Upon confirmation from the remote apparatus 40, inserted by its user, the response form thus created is stored by the processor 10 in the memory 20.

The response form will be provided to final users which will access the multimedia content through their devices. The response form can be shown simultaneously with respect to the multimedia content, or at a later time (e.g., in a subsequent page). The response form will give the final users the possibility to provide personal data (e.g., email address) in order to receive further information.

In the following, the response form—in case it is generated—will be considered part of the overall multimedia content.

The processor 10 is further configured to create a main link that points, in memory 20, to the overall multimedia content, i.e., to all the information/data necessary to display the multimedia content according to the selected template and the material loaded by the user of the remote apparatus 40.

The main link is the sent from the processor 10 to the remote apparatus 40. The user of the remote apparatus 40 can thus employ such main link in order to autonomously distribute the digital content.

In one embodiment, the processor 10 is configured to take care of the distribution of the overall multimedia content.

In more detail, the processor 10 is configured to receive, from the remote apparatus 40, a list of contacts.

The contacts can be in the form of telephone numbers, email addresses, contacts of social networks, etc.

Preferably, the processor 10 prompts the user of the remote apparatus 40, through the graphical user interface 100, to upload the list of contacts.

Once the overall multimedia content has been defined and the list of contacts has been uploaded, the processor 10 provides for distribution of the main link (pointing to the overall multimedia content) to the contacts of the list of contacts.

For example, the list of contacts is a list of telephone numbers of mobile phones. Thus, through a GSM/UMTS/LTE interface, which is part of the electronic system 1, the processor 10 sends an SMS message to each contact, the SMS including the aforesaid main link, possibly associated with a text portion briefly describing the content associated with the same main link. Once the users of such mobile phones tap on the main link, the overall multimedia content will be displayed on the screen of the mobile phones.

In addition or as an alternative, the main link can be sent (by the processor 10 or the remote apparatus 40) to servers adapted to manage social networks so as to distribute the main link (and the overall multimedia content associated thereto) through one or more social networks. For example, it is envisaged to exploit the “Open Graph” protocol, supported by a number of social networks, in order to provide for distribution of the main link associated to the overall multimedia content.

In one embodiment, the main link generated by the processor 10 to access/download the overall multimedia content can be sent/broadcast to an unspecified number of devices and can be used an unspecified number of times, so that, in principle, any device at any time can access/download the overall multimedia content.

In one embodiment, the main link generated by the processor 10 to access/download the overall multimedia content contains or is associated to a restricted-use feature. In this case, the main link can be used only by specific users and/or can be used only a limited number of times.

From a practical point of view, the processor 10 can configured to check, in a prestored whitelist, whether an access request to the overall multimedia content (generated by clicking/tapping on the main link) comes from a user that is allowed to access the overall multimedia content and/or to count how many times the main link has been used (i.e., how many access requests have been received based on the main link). Depending on the outcome of such check(s), access to the overall multimedia content will be granted or not.

In one embodiment, the overall multimedia content can include features for supporting the final user to purchase products/services online. In more detail, the overall multimedia content can comprise material descriptive of the products/services that can be purchased, and a purchase link. Once tapped or clicked on, the purchase link redirects the device of the final user to a marketplace, which provides for the finalization of the purchase and relative financial transaction.

In one embodiment, the financial transaction is carried out in such a way that, upon payment by the final user (for example, through conventional credit card systems), the amount of money is transferred from the final user to an account associated with the electronic system 1; the processor 10 is then configured to provide an account associated with the remote apparatus 40 with a corresponding amount, in the form of money or other credits.

Regarding the final user, once he/she receives the main link on his/her device, he/she will access the overall multimedia content, previously arranged through the graphical user interface 100 by the user of the remote apparatus 40.

The final user can receive the main link, for example, by SMS, by email, through a social network, etc.

When the main link is initially displayed on the remote user's device, it is preferably coupled to or visually replaced by the representative image associated to the multimedia contents.

The final user, by tapping or clicking on the main link, will thus display images, videos, etc. associated to the main link. He/she also will have the possibility to take advantage of the features included in the overall multimedia content, such as: direct link to Apple® Store or Google® Play in order to download an app, direct link to a marketplace for purchasing products/services online, direct link to official websites associated to events and/or locations, fill in the response form in order to further exchange information with the system, etc.

Preferably, the final user's device needs merely a web browser in order to access the overall multimedia content. In fact, as said, the material uploaded through the remote apparatus 40 is processed by the processor 10 in order to render the same material accessible/usable through an internet connection, in particular by mobile devices.

In other terms, in the preferred embodiment, it is not necessary to install any dedicated software program (e.g., application software) on the final user device in order to let the latter access the overall multimedia content. A conventional web browser (such as Safari®, Google Chrome®, Internet Explorer®, etc.) is sufficient.

According to one aspect, the invention is directed to the method carried out by the remote apparatus 40.

The remote apparatus 40, which is an electronic apparatus such as, for example, a computer, a tablet, a smartphone, etc., accesses the internet in order to establish an internet connection with the electronic system 1 which, as said, is an electronic system for management of digital multimedia contents.

The remote apparatus 40 receives from the electronic system 1 a graphical user interface 100, which the remote apparatus 40 displays on a display or screen included in the same remote apparatus 40.

The remote apparatus 40, through the graphical user interface 100, displays a plurality of templates provided by the electronic system 1, and in particular by the processor 10.

The remote apparatus 40, upon reception of a respective command from the electronic system 1, prompts the user to select one of said templates.

Once a template has been selected, notification is sent to the electronic system 1. Moreover, the templates other than the selected templates are deleted from the display/screen of the remote apparatus 40. This allows, for example, an enlargement of the selected template in the graphical user interface 100.

The remote apparatus 40 then receives indications to fill in the selected template with on ore more items.

The item(s) can include:
one or more images;
one or more videos;
one or more audio files;
one or more test portions.

Preferably, for each indication receives, the remote apparatus 40 sends respective signals to the electronic system 1, and in particular to the processor 10.

The items arranged according to the selected template define an overall multimedia content.

As disclosed above, the overall multimedia content is then stored in the memory 20 of the electronic system 1.

The remote apparatus 40 then receives a main link, which points to the overall multimedia digital content. The link can be sent to one or more final users, so as to let such users access the overall multimedia content.

What is claimed is:

1. An electronic system for managing digital multimedia contents comprising:
a processor;
a memory coupled to said processor;
an internet communication interface coupled to said processor and providing internet connectivity to said processor;
said processor being configured to communicate with at least one remote apparatus through said internet communication interface;
wherein said processor is configured to:
provide said remote apparatus with a graphical user interface;
receive through said graphical user interface, from said remote apparatus, indications to arrange, according to a determined arrangement, one or more items including one or more of the following:
one or more images;
one or more videos;
one or more audio files;
one or more text portions;
wherein said one or more items arranged according to said determined arrangement define an overall digital multimedia content;
store in said memory said overall digital multimedia content;
generate a main link to retrieve in said memory said overall digital multimedia content;
provide said main link to said remote apparatus through said internet communication interface.

2. The electronic system according to claim 1, wherein said processor is configured to:
display through said graphical user interface a plurality of templates;
prompt a user of said remote apparatus to select one of said templates;
receive from said remote apparatus a selection signal, representative of a selected template among said templates;
said determined arrangement being defined by said selected template.

3. The electronic system according to claim 1, wherein said processor is configured to prompt the user of said remote apparatus to generate a selection signal to select among the following types of digital multimedia contents:
Images;
Videos;
Event;
Location.

4. The electronic system according to claim 3, wherein the selection signal is representative of the selection of the Event type, wherein said processor is configured to:
prompt the user of the remote apparatus to input time reference data associated with the event;
store the time reference data in said memory, in association with the items inserted in said selected template.

5. The electronic system according to claim 4, wherein said processor is configured to:
prompt the user of the remote apparatus to input geographical reference data associated with the event;
store the geographical reference data in said memory, in association with the items inserted in said selected template.

6. The electronic system according to claim 3, wherein the selection signal is representative of the selection of the Location type, wherein said processor is configured to:
prompt the user of the remote apparatus to input geographical reference data associated with the location;
store the geographical reference data in said memory, in association with the items inserted in said selected template.

7. The electronic system according to claim 5, wherein said processor is configured to store in said memory, instructions/data associated to said geographical reference data which, when provided to an electronic device, display an indication item on a map displayed on a screen of said electronic device, said indication item being representative of said geographical reference data in said map.

8. The electronic system according to claim 6, wherein said processor is configured to store in said memory, instructions/data associated to said geographical reference data which, when provided to an electronic device, display an indication item on a map displayed on a screen of said electronic device, said indication item being representative of said geographical reference data in said map.

9. The electronic system according to claim 1, wherein said processor is configured to:
receive from said remote apparatus a list of contacts;
send said main link to the contacts of said list of contacts.

10. The electronic system according to claim 1, wherein said processor is configured to:
prompt the user of said remote apparatus to create a response form;
receive instruction for creation of said response form;
store the response form in said memory, in association with said overall digital multimedia content.

11. A method for managing digital multimedia contents, comprising:
establishing an internet connection between a processor and a remote apparatus;
activating the processor to provide the remote apparatus with a graphical user interface;
activating said processor to display through said graphical user interface a plurality of templates;
activating said processor to prompt a user of said remote apparatus to select one of said templates;
receiving at said processor, through said graphical user interface, from said remote apparatus, indications to arrange, according to a determined arrangement, one or more items including one or more of the following:
one or more images;
one or more videos;
one or more audio files;
one or more text portions;
wherein said one or more items arranged according to said determined arrangement define an overall digital multimedia content, the method further comprising:
storing in said memory said overall multimedia digital content;
generating a main link to retrieve in said memory said overall multimedia digital content;
providing said main link to said remote apparatus through said internet communication interface.

12. A non-transitory computer readable storage medium storing one or more programs comprising instructions, which when executed by an electronic system cause the electronic system to:
establish an internet connection between a processor of said electronic system and a remote apparatus;
activate the processor to provide the remote apparatus with a graphical user interface;
receive at said processor, through said graphical user interface, from said remote apparatus, indications to arrange, according to a determined arrangement, one or more items including one or more of the following:
one or more images;
one or more videos;
one or more audio files;
one or more text portions;
wherein said one or more items arranged according to said determined arrangement define an overall digital multimedia content;
store in said memory said overall multimedia digital content;
generate a main link to retrieve in said memory said overall multimedia digital content;
provide said main link to said remote apparatus through said internet communication interface.
